(19) United States
(12) Patent Application Publication
(10) Pub. No.: US 2005/0025916 A1
(43) Pub. Date: Feb. 3, 2005

(54) Transfer sheet

(76) Inventor: Hideki Nakanishi, Osaka (JP)

Correspondence Address: BIRCH STEWART KOLASCH & BIRCH, PO BOX 747, FALLS CHURCH, VA, 22040-0747, US

(21) Appl. No.: 10/181,736

(22) PCT Filed: Nov. 30, 2001
(86) PCT No.: PCT/JP01/10468

(30) Foreign Application Priority Data
Nov. 30, 2000 (JP) 2000-365264

(51) Int. Cl. B41M 5/00

(52) U.S. Cl. 428/32.69

(57) ABSTRACT

A transfer sheet comprises a support and a transfer layer separable from the support, the transfer layer comprises at least a hot-melt adhesive resin and a masking agent (e.g., a white pigment). The average particle size of the white pigment is not larger than 3 μm, and preferably about 0.01 to 3 μm. As the white pigment, a titanium oxide is preferred.

### TECHNICAL FIELD

The present invention relates to a transfer sheet for an ink jet printer useful in forming a transfer image on an object (in particular, a deep-colored object) such as clothes by forming a record image with the use of an ink jet printer and transferring the record image to the object (or member).

### BACKGROUND ART

Since an ink jet recording system is easily applicable to full-color image production, and is less noisy and superior in print quality, its system has been employed for recording an image onto a transfer sheet. From the viewpoints of safety and suitability for recording, a water-based ink is predominantly employed in the ink jet recording, and the recording is carried out by ejecting droplets of ink from a nozzle against a sheet. Therefore, the transfer sheet requires high ink-absorption ability and ink-fixability. Moreover, since the transfer sheet forms a transfer image by thermal-transferring a record image to an object (object to be transferred) such as clothes, the sheet requires high water resistance and washing resistance with thermal transferability and adhesiveness. Furthermore, it is necessary for the transfer sheet to achieve forming a sharp or clear image regardless of a kind of the object. For example, even when the object is deep-colored one, it is necessary to achieve forming a sharp or clear image.

For example, Japanese Patent Application Laid-Open No. 290560/1997 (JP-9-290560A) discloses an image-receiving sheet for ink jet comprising a release support and a transfer layer formed on the release support, wherein the transfer layer contains a filler particle and a water-soluble thermoplastic resin. Moreover, Japanese Patent Application Laid-Open No. 16382/1998 (JP-10-16382A) discloses a transfer medium for an ink jet recording which comprises a support, a release layer and a transfer layer containing a fine particle of a thermoplastic resin and a polymeric adhesive of a thermoplastic resin disposed on the support. Furthermore, Japanese Patent Application Laid-Open No. 250222/1998 (JP-10-250222A) discloses a thermal-transfer medium for ink jet which comprises a support and a thermal-transfer layer containing a thermoplastic polymeric resin and a thermosetting polymeric resin.

However, since the ink-receiving layers of these transfer sheets are inadequate in ink-fixability and water resistance (in particular, washing resistance), a sharp transfer image can not be maintained for a long term even when a record image is thermal-transferred to clothes or the like. Moreover, when a record image is formed to a colored object (in particular, an object being deep-colored or having low brightness such as blue-colored and black-colored), the record image becomes unclear.

Japanese Patent Application Laid-Open No. 78269/1999 (JP-11-78269A) discloses a thermal-transfer sheet in which an ink-receiving layer composed of a cationic polymer and/or a urethane-series polymer, a hydrophilic polymer and a hot-melt adhesive is formed. The thermal-transfer sheet is improved in water resistance, ink-absorption and washing resistance. However, in the thermal-transfer sheet, ink-absorption is also inadequate, in addition, a record image formed on a deep-colored object becomes unclear.

Accordingly, an object of the present invention is to provide a transfer sheet which may form a record image on an object (object to be transferred) sharply or clearly even when the object is colored, and a method for forming a record image with use of the same.

It is another object of the present invention to provide a transfer sheet which may form a sharp or clear record image to an object being deep-colored or having low brightness, and may adhere a thermal-transferred record image to the object strongly, and a method for forming a record image with use of the same.

It is still another object of the present invention to provide a transfer sheet which may form a sharp or clear record image to an object being deep-colored or having low brightness, and is excellent in texture (softness) of the object in case of thermal-transferring a record image, and a method for forming a record image with use of the same.

It is further object of the present invention to provide a transfer sheet which is excellent in water resistance and washing resistance, and can maintain a sharp or clear record image thermal-transferring to an object for a long term, and a method for forming a record image with use of the same.

### DISCLOSURE OF INVENTION

The inventors of the present invention did intensive research, and finally found that a transfer sheet can mask a color of an object (object to be transferred) when a transfer layer comprises a masking agent (covering agent or veiling agent). That is, even when the object is a deep-colored one, the transfer sheet can form a record image sharply or clearly. The present invention was accomplished based on the above findings.

Thus, the transfer sheet of the present invention comprises a support (or a substrate) and a transfer layer separable from the support, and the transfer layer comprises at least a hot-melt adhesive resin and a masking agent (covering agent or veiling agent). The masking agent may comprise a fine particle and a microcapsule, wherein the fine particle comprises at least a white pigment, and the microcapsule is capable of whitening. The average particle size of the white pigment is not larger than 3 μm, preferably about 0.01 to 3 μm. As the white pigment, a titanium oxide is preferred. The fine particle may comprise a resin fine particle (a fine particle of a resin) containing a white pigment, and a resin constituting the resin fine particle may comprise a hot-melt adhesive resin. The average particle size of the microcapsule may be not larger than 50 μm, and the microcapsule may expand not less than three times by volume by heating at 150° C. for one minute. Since the transfer sheet is excellent in masking property, it is preferred to use to form an image to a deep-colored object.

According to the transfer sheet of the present invention, a transfer layer may be formed as an image-receiving layer containing a hot-melt adhesive resin fine particle, a binder resin and a masking agent. The image-receiving layer may further comprise a dye fixing agent. In the image-receiving layer, the amount of each component is about 0.1 to 20 parts by weight of the binder resin, about 1 to 30 parts by weight of the masking agent, and about 0.5 to 30 parts by weight of the dye fixing agent relative to 100 parts by weight of the hot-melt adhesive resin. From the viewpoint of water resistance and washing resistance, the transfer layer may comprise a protecting layer separable from a support, and an image-receiving layer formed on the protecting layer. The protecting layer may comprise a cationic resin or a urethane-series resin. A transfer sheet composed of a transfer layer having such a structure is suitable for utilizing as a transfer sheet in which a formed record image is allowed to reverse by transferring. Such a transfer sheet (hereinafter, refers to a reverse image-mode (negative-mode) transfer sheet) realizes that a reverse image of a record image preformed on the transfer sheet is formed on an object. That is, the present invention includes a method which comprises recording an image (particularly, reverse image) onto an image-receiving layer of the transfer sheet by means of an ink jet recording system, heating the image-receiving layer with the layer contacted with a colored object, and then separating the image-receiving layer from a support, and transferring the imaged layer to the object to form a record image on the object.

According to the transfer layer of the present invention, a transfer layer may comprise an adhesive layer capable of separable from a support and comprising at least a hot-melt adhesive resin, and an image-receiving layer formed on the adhesive layer and comprising a binder resin and a dye fixing agent, and at least one layer among the adhesive layer and the image-receiving layer may comprise a masking agent. In the transfer sheet, the adhesive layer may comprise the hot-melt adhesive resin and the masking agent, and the ratio of the hot-melt adhesive resin relative to the masking agent (weight ratio) may be about 99/1 to 30/70. Moreover, in the transfer sheet, the image-receiving layer may comprise the masking agent, and the -ratio of the binder resin relative to the masking agent (weight ratio) may be about 99/1 to 30/70. In the image-receiving layer, the ratio of the binder resin relative to the dye fixing agent (weight ratio) is about 99/1 to 60/40. A transfer sheet composed of a transfer layer having such a structure is suitable for utilizing as a transfer sheet in which a formed record image is transferred to an object without reversing the image. Such a transfer sheet (hereinafter, refers to an obverse image-mode (positive-mode) transfer sheet) realizes that an obverse image as the same as a preformed record image is formed on an object. That is, the present invention includes a method which comprises recording an image (particularly, obverse image) onto an image-receiving layer of the transfer sheet by means of an ink jet recording system, separating a support from an adhesive layer, heating the adhesive layer with the layer contacted with a colored object, and transferring the adhesive layer and the imaged layer to the object to form a record image on the object.

### BEST MODE FOR CARRYING OUT THE INVENTION

The transfer sheet of the present invention comprises a support and a transfer layer separable (or releasable) from the support.

[Support]

As a support (or a substrate), any of supports such as opaque, semitransparent and transparent supports can be used as far as the transfer layer is capable of separating from the support. Examples of the support usually include a release (releasable) support, for example, a release-treated paper (a release paper), a synthetic paper, a chemical (artificial) fiber paper and a plastic film, and each may be treated for providing releasability.

As a paper constituting the release-treated paper (a release paper), there may be mentioned a paper (a paper for printing, a package (or wrapping) paper, a thin paper, etc.). The paper may be subjected to a variety of processing such as lamination or surface-coating by a polypropylene, a polystyrene and the like.

As a synthetic paper, there may be mentioned, a variety of synthetic papers such as a paper made with a polypropylene and a polystyrene.

As a chemical fiber paper, there may be mentioned, a variety of chemical fiber papers made with a chemical fiber such as a nylon fiber, an acrylic fiber, a polyester fiber and a polypropylene fiber.

As a polymer constituting the plastic film, a variety of resins (a thermoplastic resin and a thermosetting resin) can be used, and a thermoplastic resin is usually employed. As the thermoplastic resin, there may be mentioned a polyolefin-series (polyolefinic) resin (e.g., a polyC₂₋₄olefin-series resin such as a polypropylene), a cellulose derivative (e.g., a cellulose ester such as a cellulose acetate), a polyester-series resin (e.g., a polyalkylene terephthalate such as a polyethylene terephthalate and a polybutylene terephthalate, a polyalkylene naphthalate such as a polyethylene naphthalate and a polybutylene naphthalate, or a copolyester thereof), a polyamide-series resin (e.g., a polyamide 6, a polyamide 6/6), a vinyl alcohol-series resin (e.g., a polyvinyl alcohol, an ethylene-vinyl alcohol copolymer), and the like. Among these films, the olefinic resin, the polyester-series resin, the polyamide-series resin or the like is usually employed. In particular, polyester-series resin (especially, a polyethylene terephthalate) is preferred from viewpoints of mechanical strength, heat resistance and workability.

The thickness of the support can be selected according to its use or application, and is usually, for example, about 10 to 250 μm, and preferably about 15 to 200 μm.

The releasability can be provided or imparted by a conventional method, for example, by treating the support with a releasing agent (e.g., a wax, a salt of a higher fatty acid, an ester of a higher fatty acid, an amide of a higher fatty acid, a silicone oil) or by containing the releasing agent in the support. In case of the paper, the releasability can be imparted by coating the paper with a releasing agent (e.g., a silicone oil) after anchor treatment (e.g., clay-coat). If necessary, to the plastic film may be added a conventional additive such as a stabilizer (e.g., an antioxidant, an ultraviolet ray absorber, a thermal stabilizer), a lubricant, a nucleation agent, a filler and a pigment.

[Transfer Layer]

The transfer layer comprises at least a hot-melt adhesive resin and a masking agent. The transfer layer masks an object being a groundwork (or ground), even if a deep-colored object is used, because the transfer sheet comprises a masking agent. As a result, a sharp or clear image can be recorded onto the object. Moreover, the transfer layer may optionally comprise a binder resin, a dye fixing agent, other additives, and others.

(Masking Agent)

The masking agent (or a masking-improvable agent) may be capable of masking an object by whitening. As the masking agent, there may be mentioned a fine particle comprising at least a white pigment, a microcapsule capable of whitening by heat expansion, and the like. The masking agent may be used singly or in combination.

The fine particle may comprise a white pigment singly, or a resin fine particle containing a white pigment.

The white pigment includes a titanium-series (titanium-containing) white pigment [a titanium oxide (white titanium pigment), etc.], a zinc-series (zinc-containing) white pigment (a zinc oxide, a zinc sulfide, etc.), a composite white pigment (a lithopone, etc.), an extender [a magnesium silicate, a magnesium oxide, a calcium carbonate, a barium sulfate, an aluminum-series (aluminum-containing) extender (an alumina, an aluminum hydroxide, an aluminum silicate, etc.), a silica, a mica, abentonite, etc.], and the like. Among the white pigments, the titanium-series white pigment, in particular the titanium oxide, is preferred.

A crystal morphology or configuration of the titanium oxide may be an anatase-type (or mode). From the viewpoint of having large refractive property and excellent masking property, a rutile-type (or mode) is preferred.

The average particle size of the white pigment is preferably not larger than 3 μm, for example, about 0.01 to 3 μm, preferably about 0.05 to 2 μm (e.g., about 0.05 to 1 μm), and more preferably about 0.1 to 1 μm (e.g., about 0.1 to 0.5 μm). In the case where the average particle size of the white pigment is too small, masking property is not enough. In the case where the average particle size of the white pigment is too large, texture or adhesiveness is deteriorated.

As a resin constituting the resin fine particle, a hot-melt adhesive resin is preferred, and for example, the same resin as a hot-melt adhesive resin described below can be used. Such a resin fine particle can be available from Dainippon Ink and Chemicals, Inc. as “Colored elastic g beads, BARNOK CFB series”.

The particle size of the resin fine particle is not larger than 100 μm (e.g., about 1 to 100 μm), preferably about 3 to 70 μm, and more preferably about 5 to 50 μm (in particular, about. 0to 30 μm). In the resin fine particle, the white pigment may be covered with a hot-melt adhesive resin, and a plurality of white pigments may be aggregated or dispersed in the resin fine particle.

The microcapsule comprises a solvent having a low-boiling point as a core material which is vaporized by heating in the thermal-transferring. The boiling point of the solvent acting as the core material is not more than 200° C., preferably about 50 to 180° C., and more preferably about 50 to 150° C. Preferred as such a solvent is, for example, an aliphatic hydrocarbon (pentane, hexane, etc.), an alicyclic hydrocarbon (cyclohexane, etc.), an aromatic hydrocarbon (toluene, xylene, etc.), an ether (1,4-dioxane, tetrahydrofuran, etc.), an ester (methyl acetate, ethyl acetate, etc.), a ketone (acetone, methyl ethyl ketone, etc.), an alcohol (methanol, ethanol, isopropanol, etc.), and particularly a hydrocarbon-series solvent (e.g., hexane).

As a wall material constituting the microcapsule, there may be mentioned a thermoplastic resin, which has high gas barrier property and is softened by heating upon thermal-transferring. For example, such a wall material includes a vinyliden chloride-series polymer [e.g., a vinyliden chloride-acrylonitrile copolymer, a vinyliden -chloride-(meth)acrylic acid copolymer, a vinyliden chloride-(meth)acrylate copolymer, a vinyliden chloride-vinyl acetate copolymer, and the like], a polyacrylonitrile-series copolymer, a vinyl alcohol-series copolymer (e.g., a polyvinyl alcohol, an ethylene-vinyl alcohol copolymer, etc.), a polyamide-series resin (e.g., a nylon 6, a nylon 66, a nylon 610, a nylon 11, a nylon 12, etc.), and others.

The average particle size of the microcapsule is preferably not larger than 50 Mm, and for example, is about 0.1 to 50 μm, preferably about 0.5 to 20 μm, and more preferably about 1 to 10 μm.

It is preferred that the microcapsule expands not less than three times (e.g., about 5 to 1000 times, preferably about 10 to 100 times, and more preferably about 10 to 50 times) by volume in case of heating at 150° C. for one minute.

(Hot-Melt Adhesive Resin)

The hot-melt adhesive resin is not particularly limited as far as the resin has thermal-adhesiveness. For example, the hot-melt adhesive resin includes a polyamide-series resin, a thermoplastic polyurethane-series resin, a polyester-series resin, an olefinic resin, and others.

(1) Polyamide-Series Resin

As the thermal-adhesive polyamide-series resin, there may be mentioned a nylon 6, a nylon 46, a nylon 66, anylon 610, a nylon612, a nylon 11, a nylon 12, a polyamide resin formed by reacting a dimer acid with a diamine, a polyamide-series elastomer (e.g., a polyamide having a polyoxyalkylene diamine as a soft segment), and the like. The polyamide-series resin may be used singly or in combination. Among them, the preferred polyamide-series resin includes a nylon having at least one unit selected from a nylon 11 and a nylon 12 (e.g., a homopolyamide such as nylon 11 and nylon 12, a copolyamide such as a nylon 6/11, a nylon 6/12, a nylon 66/12, and a copolymer of a dimer acid, a diamine and a laumlactam or an aminoundecanoic acid), a polyamide resin formed by reacting a dimer acid and a diamine.

(2) Thermoplastic Polyurethane-Series Resin

Exemplified as the thermoplastic polyurethane-series resin is, for example, a thermoplastic resin or thermoplastic elastomer obtained by reacting of a diisocyanate component with a diol component.

As the diisocyanate component, there may be mentioned an aromatic diisocyanate (e.g., phenylene diisocyanate, tolylene diisocyanate, etc.), an araliphatic diisocyanate (e.g., xylylene diisocyanate, etc.), an alicyclic diisocyanate (e.g., isophorone diisocyanate, etc.), an aliphatic diisocyanate (e.g., 1,6-hexamethylene diisocyanate, lysine diisocyanate, etc.), and the like. Adducts of a diisocyanate compound may be used as the diisocyanate component. If necessary, a polyisocyanate component such as triphenylmethane truisocyanate may be used in combination. The diisocyanate component may be used singly or in combination.

As examples of the diol component, there may be mentioned a polyester diol, a polyether diol (a polytetramethylene ether glycol, etc.), and the like. The diol component may be used singly or in combination.

The polyester diol may be a polyester diol derived from a lactone, not being limited to a polyester diol obtained by reacting a diol with a dicarboxylic acid or a reactive derivative thereof (e.g., a lower alkyl ester, an acid anhydride). As examples of the diol, there may be mentioned an aliphatic diol (e.g., a C₂₋₁₀alkylene diol such as ethylene glycol, trimethylene glycol, propylene glycol, 1,3-butanediol, 1,4-butanediol, hexamethylene glycol, neopentyl glycol; a polyoxyC₂₋₄alkylene glycol such as diethylene glycol, triethylene glycol), an alicyclic diol, an aromatic diol, and the like. The diol may be used singly or in combination. If necessary, a polyol such as trimethylol propane and pentaerythritol may be used in combination with the above diol. As examples of the dicarboxylic acid, there may be mentioned an aliphatic dicarboxylic acid (e.g., a C₄₋₁₄aliphatic dicarboxylic acid such as adipic acid, suberic acid, azelaic acid, sebacic acid, dodecanedicarboxylic acid, etc.), an alicyclic dicarboxylic acid, an aromatic dicarboxylic acid (e.g., phthalicacid, terephthalic acid, isophthalicacid, etc.), and the like. The dicarboxylic acid may be used singly or in combination. If necessary, a polycarboxylic acid such as trimellitic acid may be used in combination with the dicarboxylic acid. As examples of the lactone, there may be mentioned butyrolactone, valerolactone, caprolactone, laurolactone, etc. The lactone may be used singly or in combination.

The thermoplastic polyurethane-series resin may be used singly or in combination.

Among the thermoplastic polyurethane-series resins, a polyester-based urethane-series resin obtained with the use of at least a polyester diol as a diol component, especially a polyester-based urethane-series resin obtained with the use of a diol component containing not less than 50% by weight (e.g., not less than 75% by weight) of an aliphatic polyester diol, is preferred. Moreover, if necessary, a urethane-series resin may be used as a thermoplastic elastomer obtained with the use of a diamine component as a chain-extending agent. As the thermoplastic urethane-series elastomer, for example, there may be mentioned an elastomer containing an aliphatic polyether or polyester as a soft segment and a polyurethane unit of a short-chained glycol as a hard segment.

(3) Polyester-Series Resin

The thermal-adhesive polyester-series resin includes a homopolyester resin, a copolyester resin and a polyester-series elastomer, which employ at least an aliphatic diol or an aliphatic dicarboxylic acid.

The homopolyester resin includes, for example, a saturated aliphatic polyester resin formed by reacting an aliphatic diol (e.g., a C₂₋₁₀alkylene diol, a polyoxyC₂₋₄alkylene glycol, which are described in the section on the polyurethane-series resin, etc.), an aliphatic dicarboxylic acid (e.g., the above-mentioned C₄₋₁₄aliphatic dicarboxylic acid), and if necessary, lactone.

The copolyester resin includes a saturated polyester resin obtained by substituting a part of components (a diol component and/or a terephthalic acid) constituting a polyethylene terephthalate or a polybutylene terephthalate with other diols (a C₂₋₆alkylene glycol such as ethylene glycol, propylene glycol and 1,4-butanediol, a polyoxyalkylene glycols such as diethylene glycol and triethylene glycol, cyclohexanedimethanol, etc.) or other dicarboxylic acids (the above aliphatic dicarboxylic acid, an asymmetric aromatic dicarboxylic acid such as phthalic acid and isophthalic acid, etc.), or lactone (butyrolactone, valerolactone, caprolactone, laurolactone, etc.).

The polyester-series elastomer includes an elastomer having a C₂₋₄alkylene arylate (ethylene terephthalate, butylene terephthalate, etc.) as a hard segment and a (poly)oxyalkylene glycol and the like as a soft segment.

A polyester resin having a urethane bond, for example, a resin in which its molecular weight is increased with the use of the diisocyanate may be employed as the polyester-series resin.

The polyester-series resin can be used singly or in combination.

(4) Olefinic Resin

The thermal-adhesive olefinic resin includes, for example, a homopolymer or copolymer of an a-olefin such as ethylene, propylene, 1-butene, 3-methyl-1-pentene, 4-methyl-1-butene, 1-hexene, 1-octene, and the like (in particular, an a-C₂₋₁₀ olefin), and an olefinic elastomer.

Exemplified as the homopolymer or copolymer of the a-olefin is a polyolefin (a polyethylene such as a low-density polyethylene and a linear low-density polyethylene, an ethylene-propylene copolymer, an atactic polypropylene, etc), a modified polyolefin [an ethylene-butene-1 copolymer, an ethylene-(4-methylpentene-1) copolymer, an ethylene-vinyl acetate copolymer, an ethylene-(meth)acrylic acid copolymer or an ionomer thereof, an ethylene-(meth)acrylate copolymer such as an ethylene-ethyl acrylate copolymer, a propylene-butene-1 copolymer, an ethylene-propylene-butene-1 copolymer, a maleic anhydride graft polypropylene, etc.], and the like. The olefinic elastomer includes an elastomer comprising a polyethylene or a polypropylene as a hard segment and an ethylene-propylene rubber (EPR) or an ethylene-propylene diene rubber (EPDM) as a soft segment.

The olefinic resin can be used singly or in combination. Among the olefinic resins, a modified polyolefin is preferred from the viewpoint of thermal-adhesiveness.

The hot-melt adhesive resin may be used singly or in combination. The hot-melt adhesive resin is usually water-insoluble. The hot-melt adhesive resin may be a reactive hot-melt adhesive resin having a reactive group (e.g., a carboxyl group, a hydroxyl group, an amino group, an isocyanate group, and a silyl group) at a terminal position. The softening point of the hot-melt adhesive resin is preferably about 70 to 180° C. (in particular, about 100 to 150° C.).

Among the hot-melt adhesive resins, the polyamide-series resin, the thermoplastic urethane-series resin and the polyester-series resin are preferred. When the object is fabrics (or cloth) such as clothes, the polyamide-series resins and the thermoplastic urethane-series resins are particularly preferred in terms of thermal-transferability, durability (e.g., washing resistance) and texture.

(Binder Resin)

The binder resin is not particularly limited as far as the resin has adhesive property and film-forming property, a variety of thermoplastic resins (e.g., a polyamide-series resin, a polyester-series resin, a styrenic resin, an olefinic resin, a cellulose derivative, a polycarbonate-series resin, a polyvinyl acetate-series resin, an acrylic resin, a vinyl chloride-series resin, a thermoplastic urethane-series resin) and thermosetting resins can be used. Among the binder resins, a hydrophilic polymer and a crosslinking-group containing polymer (a polymer of a polymerizable unsaturated monomer containing a crosslinking group(s)) are preferred. The binder resin may be used singly or in combination.

(1) Hydrophilic Polymer

The hydrophilic polymer includes a variety of polymers having an affinity for water, for example, a water-soluble polymer, a water-dispersible polymer, and a polymer which is water-insoluble and has water-absorbing.

As the hydrophilic polymer, there maybe mentioned, for example, a polyoxyalkylene glycol (e.g., a polyoxyC₂₋₄alkylene glycol such as a polyethylene glycol, a polypropylene glycol, an ethylene oxide-propylene oxide block copolymer, and a polytetramethylene ether glycol), an acrylic polymer [e.g., a poly(meth)acrylic acid or a salt thereof, a methyl methacrylate-(meth)acrylic acid copolymer, an acrylic acid-polyvinyl alcohol copolymer], a vinyl ether-series polymer (e.g., a polyvinyl alkyl ether such as a polyvinyl methyl ether and a polyvinyl isobutyl ether, a C₁₋₆alkyl vinyl ether-maleic anhydride copolymer), a styrenic polymer [e.g., a styrene-maleic anhydride copolymer, a styrene-(meth)acrylic acid copolymer, a polystyrenesulfonic acid or a salt thereof], a vinyl acetate-series polymer [e.g., a vinyl acetate-(meth)acrylic acid copolymer, a vinyl acetate-methyl acrylate copolymer], a vinyl alcohol-series polymer (e.g., a polyvinyl alcohol, a modified polyvinyl alcohol, an ethylene-vinyl alcohol copolymer), a cellulose derivative (e.g., a cellulose ether such as methyl cellulose, ethyl cellulose, hydroxyethyl cellulose and carboxymethyl cellulose, a cellulose ester such as cellulose acetate), a hydrophilic natural polymer or a derivative thereof (e.g., an alginic acid or a salt thereof, a gum arabic, a gelatin, a casein, a dextrin), a nitrogen-containing polymer (or a cationic polymer) or a salt thereof [e.g., a quaternary ammonium salt such as a polyvinylbenzyltrimethylannmonium chloride, and a polydiallyldimethylammonium chloride, a polydimethylaminoethyl (meth)acrylate hydrochloride, a polyvinylpyridine, a polyethylene imine, a polyacryl amide, a polyvinyl pyrrolidone], and the like. The salt of the hydrophilic polymer (in particular, a salt of a carboxyl group or a sulfonic acid group) includes an ammonium salt, an amine salt, and an alkali metal salt such as sodium salt, and others. The hydrophilic polymer can be used singly or in combination.

Among the hydrophilic polymers, a hydroxyl group-containing hydrophilic polymer [for example, a polyoxyalkylene glycol, a vinyl alcohol-series polymer (a polyvinyl alcohol, a modified polyvinyl alcohol), a cellulose derivative (e.g., a hydroxyethylcellulose)], a carboxyl group-containing hydrophilic polymer (e.g., an acrylic polymer), a nitrogen-containing polymer (e.g., a cationic polymer, a polyvinylpyrrolidone) is preferred.

(2) Crosslinking Group-Containing Polymer

Exemplified as the crosslinking group-containing polymer is a thermosetting or crosslinking resin, a self-crosslinking resin (a thermoplastic resin having a self-crosslinking group), and the like.

The thermosetting or crosslinking resin includes, for example, a polyurethane-series resin, an unsaturated polyester-series resin, a vinyl ester-series resin, an epoxy-series resin, a phenolic resin, a silicone-series resin, and others.

For example, the self-crosslinking resin includes a polyester-series resin, a polyamide-series resin, an acrylic resin, an olefinic resin, etc. The self-crosslinking resin comprises a polymer composed of a monomer having at least a self-crosslinking group as a constituting unit. The monomer having the self-crosslinking group (or self-crosslinking group-containing monomer) includes, for example, an epoxy group-containing monomer [e.g., glycidyl (meth)acrylate, etc.], a methylol group-containing monomer or a derivatives thereof [e.g., N-methylol (meth)acrylamide, N-butylol (meth)acrylamide], a monomer containing a hydrolyzed condensate group such as silyl group [e.g., a vinyltrimethoxysilane, a vinylmethoxydimethylsilane, a vinyltrichlorosilane, an allyltrichlorosilane], an aziridinyl group-containing monomer [e.g., 2-(1-aziridinyl)ethyl (meth)acrylate], and others. The self-crosslinking monomer can be used singly or in combination. The preferred self-crosslinking monomer has a hydrolyzed condensate group, in particular, an alkoxysilyl group (e.g., a C₁₋₄alkoxy silyl group such as methoxysilyl group, ethoxysiliyl group).

The self-crosslinking group-containing polymer may comprise a self-crosslinking group-containing monomer singly, and usually comprises a self-crosslinking group-containing monomer and a copolymerizable unsaturated monomer (a copolymerizable component). The copolymerizable component includes a hydrophilic monomer (a carboxyl group-containing monomer, a hydroxyl group-containing monomer, etc.), a cationic monomer [dimethylamino-ethyl(meth)acrylamide, dimethylamino-ethyl(meth)acrylate, vinyl pyrrolidone, etc.], and the like.

The form of such a crosslinking group-containing polymer may be an aqueous solution, or an aqueous emulsion. An emulsion containing the crosslinking group-containing polymer can be obtained by a conventional method, for example, a method which comprises emulsion-polymerizing the monomer in the emulsion-polymerization system containing a surfactant (e.g. , at least one member selected from a nonionic surfactant, an anionic surfactant and a cationic surfactant), a method which comprises polymerizing by using a monomer component having an ionic functional group such as a carboxyl group and an amino group as a copolymerizable component without using an emulsifier (or an emulsifying agent) to obtain an aqueous emulsion, and others.

The crosslinking group-containing polymer may be used singly or in combination. Among the crosslinking group-containing polymers, a self-crosslinking acrylic resin (e.g., an acrylsilicone resin, etc.) is particularly preferred.

(Dye Fixing Agent)

Further, the transfer layer may contain a cationic compound (dye fixing agent having a low molecular weight), a polymeric dye fixing agent, and the like, as a dye fixing agent in order to improve a fixability of a coloring agent (dye). In particular, when the hot-melt adhesive resin or the binder resin is non-cationic, it is preferred that the dye fixing agent is employed. The dye fixing agent can be used singly in combination. Among the dye fixing agents, a cationic compound, in particular, a quaternary ammonium salt is preferred.

(1) Cationic Compound

The cationic compound includes an aliphatic amine salt, a quaternary ammonium salt (e.g., an aliphatic quaternary ammonium salt, an aromatic quaternary ammonium salt, a heterocyclic quaternary ammonium salt), and the like. The cationic compound can be used singly or in combination. The preferred cationic compound includes an aliphatic quaternary ammonium salt (e.g., a tetraC₁₋₆alkylammonium halide such as tetramethylammonium chloride, tetraethylammonium chloride, tetramethylammonium bromide and tetraethylammonium bromide, a triC₁₋₆alkylC₈₋₂₀alkylammonium halide such as trimethyllaurylammonium chloride and trimethyllaurylammonium bromide, a diC₁₋₆alkyldiC₈₋₂₀alkylammonium halide such as dimethyldilaurylammonium chloride and dimethyldilaurylammonium bromide), especially a tetraC₁₋₄alkylammonium halide (e.g., a tetraC₁₋₂alkylammonium halide), a triC₁₋₄alkylC₁₀₋₁₆alkylammonium halide (e.g., a triC₁₋₂alkylC₁₀₋₁₄alkylammonium halide), a diC₁₋₄alkyldiC₁₀₋₁₆alkylammonium halide (e.g., a diC₁₋₂alkyldiC₁₀₋₄alkylammoniumhalide). The cationic compound may be used singly or in combination.

(2) Polymeric Dye Fixing Agent

The polymeric dye fixing agent usually has a cationic group (in particular, a strong cationic group such as a guanidyl group and a quaternary ammonium salt group) in its molecule. As the polymeric dye fixing agent, there may be mentioned, for example, a dicyane-series compound (e.g., a dicyanediamide-formaldehyde polycondensate), a polyamine-series compound [e.g., an aliphatic polyamine such as diethylenetriamine, an aromatic polyamine such as phenylenediamine, a condensate of a dicyandiamide and a (poly)C₂₋₄alkylenepolyamine (e.g., a dicyanediamide-diethylenetriamine polycondensate)], a polycationic compound and the like. As the polycationic compound, there may be mentioned, for example, an epichlorohydrine-diC₁₋₄alkylamine addition polymer (e.g., an addition polymer of an epichlorohydrine-dimethylamine), a polymer of an allylamine or its salt (e.g., a polymer of an allylamine or its salt, a polymer of a polyallylamine or its hydrochloride), a polymer of a diallylC₁₋₄alkylamine or its salt (e.g., a polymer of a diallylmethylamine or its salt), a polymer of a diallyldiC₁₋₄alkylammonium salt (e.g., a polymer of a diallyldimethylammonium chloride), a copolymer of a diallylamine or its salt and a sulfur dioxide (e.g., diallylamine salt-sulfur dioxide copolymer), a diallyldiC₁₋₄alkylammonium salt-sulfur dioxide copolymer (e.g., diallyldimethylammonium salt-sulfur dioxide copolymer), a copolymer of a diallyldiC₁₋₄alkylammonium salt and a diallylamine or its salt or its derivative (e.g., a copolymer of a diallyldimethylammonium salt-diallylamine hydrochloride derivative), a diallyldiC₁₋₄alkylammonium salt polymer (e.g., diallyldimethylammonium salt polymer), a dialkylaminoethyl(meth)acrylate quaternary salt polymer [e.g., a diC₁₋₄alkylaminoethyl(meth)acrylate quaternary salt polymer], a diallyldiC₁₋₄alkylammonium salt-acrylamide copolymer (e.g., a diallyldimethylammonium salt-acrylamide copolymer), an amine-carboxylic acid copolymer, and the like. The polymeric dye fixing agent can be used singly or in combination.

(Additives)

If necessary, the transfer layer may contain a variety of additives, for example, stabilizers (e.g., antioxidants, ultraviolet ray absorbers, thermal stabilizers), dyes, other pigments, antistatic agents, flame retardants, lubricants, antiblocking agents, fillers, coloring agents, antifoaming agents, coatability improvable agents, thickeners and the like.

In the present invention, the transfer layer is classified broadly into a transfer layer of a reverse image-mode (negative-mode) transfer sheet and a transfer layer of obverse image-mode (positive-mode) transfer sheet.

[Transfer Layer of Reverse Image-Mode Transfer Sheet]

It is preferred that the transfer layer of a reverse image-mode transfer sheet comprises an image-receiving layer containing a hot-melt adhesive resin fine particle, a binder resin and a masking agent. Since the reverse image-mode transfer sheet is adhered to an object on (or at) a surface opposite to a surface separable (releasable) from a support, from the viewpoint of clearness of a record image, it is necessary to form an image by letting ink absorbed in vicinity to a support side of the transfer layer. Therefore, the transfer layer requires high ink-absorption ability with high adhesiveness to an object. With the transfer layer comprising the above-mentioned composition, the transfer layer is excellent in texture or adhesiveness to an object with being excellent in ink-absorption ability and achieving to transfer an image clearly to a deep-colored object.

(Image-Receiving Layer)

As the above-mentioned hot-melt adhesive resin fine particle, the above-mentioned hot-melt adhesive resin can be used. The polyamide-series resin fine particle, in particular the nylon fine particle, is preferred. The melting point of the hot-melt adhesive resin fine particle is not particularly limited, and is about 50 to 250° C., preferably about 60 to 200° C., more preferably about 70 to 150° C. (e.g., about 70 to 120° C.), and particularly about 90 to 120° C. The average particle size of the hot-melt adhesive resin fine particle is about 1 to 100 μm, preferably about 3 to 80 μm, and more preferably about 5 to 50 μm.

As the binder resin, a hydrophilic polymer (e.g., a polyoxyalkylene glycol such as a polyethylene glycol) is preferred. The weight-average molecular weight of the hydrophilic polymer is about 100 to 50000, preferably about 500 to 10000, and more preferably about 1000 to 5000. The amount of the binder resin is about 0.1 to 20 parts by weight, preferably about 0.5 to 15 parts by weight, and more preferably about 1 to 10 parts by weight relative to 100 parts by weight of the hot-melt adhesive resin fine particle.

The amount of the masking agent is about 1 to 30 parts by weight, preferably about 5 to 20 parts by weight, and more preferably about 10 to 15 parts by weight relative to 100 parts by weight of the hot-melt adhesive resin. A transfer layer which is excellent in balance of masking property (image clearness) and texture or transferability can be obtained by comprising the masking agent within such a range.

The image-receiving layer preferably further comprises the dye fixing agent in terms of ink-fixability. As the dye fixing agent, a cationic compound, in particular a quaternary ammonium salt, is preferred. The amount of the dye fixing agent is about 0.5 to 30 parts by weight, preferably about 1 to 25 parts by weight, and more preferably about 5 to 20 parts by weight relative to 100 parts by weight of the hot-melt adhesive resin fine particle.

The image-receiving layer may comprise the additive(s). In particular, the image-receiving layer may comprise an adhesion imparting agent (a rosin or a derivative thereof, a hydrocarbon-series resin, etc.), a wax and the like.

The thickness of the image-receiving layer is about 10 to 300 μm, preferably about 30 to 250 μm, and more preferably about 50 to 200 μm (in particular, about 60 to 150 μm).

(Protecting Layer)

It is preferred that a protecting layer separable from the support is disposed between the image-receiving layer and the support, and the transfer layer comprises the image-receiving layer and the protecting layer. The protecting layer serves as a protector for a surface of an image-receiving layer (a transfer image) transferred to an object, and enhances washing resistance and water resistance.

As the protecting layer, a variety of thermoplastic resins and thermosetting resins can be used as far as the protecting layer does not degrade extremely the quality of a transfer image. It is preferred that the protecting layer comprises a urethane-series resin (e.g., the above-mentioned thermoplastic urethane-series resins) and/or a cationic resin, in particular a cationic thermoplastic urethane-series resin, since such a resin has high wettability or compatibility toward a support and has high plasticity and flexibility (suppleness).

As the cationic thermoplastic urethane-series resin, there may be mentioned such a urethane-series resin as a tertiary amino group or a quaternary ammonium salt is incorporated into a molecular of a thermoplastic urethane-series resin exemplified in the above-mentioned hot-melt adhesive resin. It is preferred that such a cationic thermoplastic urethane-series resin is used as an organic solvent solution, an aqueous solution, and an aqueous emulsion. The aqueous solution or the aqueous emulsion of the urethane-series resin may be prepared by dissolving or emulsion-dispersing a urethane-series resin with the use of an emulsifying agent, or by introducing a tertiary amino group into a molecule of a urethane-series resin and dissolving or dispersing the urethane-series resin with the use of an alkali or an acid. Such a urethane-series resin in which a free tertiary amino group is introduced into its molecule comprises a urethane-series resin obtained by reacting a diisocyanate component with a diol component having a free tertiary amino group (in particular, a polymeric diol). Incidentally, the diol having a tertiary amino group (especially, a polymeric diol) can be prepared by ring-opening-polymerizing an alkyleneoxide or a lactone with the use of N-methyldiethanolamine or the like as an initiator. Further, the tertiary amino group may form a quaternary ammonium salt.

The protecting layer may comprise the above-mentioned additive(s). The thickness of the protecting layer is not less than 1 μm (e.g., about 1 to 50 μm), preferably about 3 to 30 μm, and more preferably about 5 to 20 μm (especially, about 7 to 15 μm).

[Transfer Layer of Obverse Image-Mode Transfer Sheet]

It is preferred that the transfer layer of an obverse image-mode transfer sheet has a layer structure which comprises an adhesive layer separable from the support and containing at least a hot-melt adhesive resin, and an image-receiving layer formed on the adhesive layer and containing a binder resin and a dye fixing agent. In the obverse image-mode transfer sheet, at least one layer out of the adhesive layer and image-receiving layer, comprises a masking agent. In the obverse image-mode transfer sheet, since a release surface of a transfer layer from a support is adhered to an object, it is advantageous from the viewpoint of clearness of a record image that most of ink is allowed to remain around a front side (the other side of the adhesive layer) of the transfer layer for forming an image, and that a larger amount of a masking agent is allowed to contain on a support side of the transfer layer. The transfer layer comprises the above-mentioned composition, as a result the transfer layer achieves transferring an image to a deep-colored object clearly.

(Adhesive Layer)

The hot-melt adhesive resin is not particularly limited, and the above-mentioned hot-melt adhesive resin can be used. It is preferred to use the polyamide-series resin and/or the thermoplastic urethane-series resin, in particular the cationic thermoplastic urethane-series resin, having excellent texture (softness).

The adhesive layer may comprise a masking agent. In the case where the adhesive layer comprises a hot-melt adhesive resin and a masking agent, the adhesive layer also functions as a masking layer. The ratio of the hot-melt adhesive resin relative to the masking agent (weight ratio) is about 99/1 to 30/70, preferably about 90/10 to 40/60, and more preferably about 80/20 to 50/50 (particularly, about 70/30 to 50/50).

Incidentally, the adhesive layer is mainly formed in order to impart thermal-transferability. Depending on a thickness of an image-receiving layer described below, the adhesive layer may absorb ink and form a record image. In the case where the adhesive layer comprises a masking agent, the adhesive layer can contribute to impart masking property against a deep-colored object.

The adhesive layer may comprise the above-mentioned additive(s). The thickness of the adhesive layer is not more than 100 Mm (e.g., about 5 to 100 μm), preferably about 10 to 80 μm, and more preferably about 20 to 70 μm.

(Image-Receiving Layer)

As the binder resin, there is not particularly limitation, and the above-mentioned binder resin can be used. In particular, a composite polymer containing a hydrophilic polymer and a crosslinking group-containing polymer is preferred. By using such a binder resin in combination with a dye fixing agent, ink-fixability of the image-receiving layer is improved.

Exemplified as the composite polymer is, for example, a graft urethane resin obtained by graft-polymerized a vinyl monomer in an aqueous solution or aqueous emulsion composed of a polyurethane-series resin (e.g., a water-soluble or water-dispersible polyurethane resin) and a hydrophilic polymer, and the like. The hydrophilic polymer includes a saponified compound of a vinyl acetate-series copolymer (e.g., a polyvinyl alcohol having 75 to 100% of degree of saponification and 500 to 5000 of polymerization degree), and the like. As the vinyl monomer, a hydrophilic vinyl monomer [e.g., (meth)acrylic acid, hydroxyethyl (math)acrylate, maleic acid, etc.] is used. In the vinyl monomer, a copolymerizable monomer [e.g., methyl (meth)acrylate, ethyl (meth)acrylate, styrene, and vinyl acetate] may be contained in the content of 40% by weight or less relative to the vinyl monomer. The amount of the hydrophilic polymer is about 10 to 500 parts by weight, and preferably about 20 to 300 parts by weight relative to 100 parts by weight of the polyurethane-series resin. The amount of the vinyl monomer is about 10 to 500 parts by weight, and preferably about 20 to 300 parts by weight relative to 100 parts by weight of the polyurethane-series resin.

The content of a polymer having a urethane unit (polyurethane resin) is, on solid basis, about 10 to 90% by weight, and preferably about 20 to 70% by weight. The ratio of the hydrophilic polymer relative to the crosslinking group-containing polymer (weight ratio) is not particularly limited, and is usually about 99/1 to 50/50, and particularly about 95/5 to 60/40.

The ratio of the binder resin relative to the dye fixing agent (weight ratio) is about 99/1 to 60/40, preferably about 97/3 to 70/30, and more preferably about 95/5 to 80/20.

The image-receiving layer may comprise a masking agent. In the case where the image-receiving layer comprises a masking agent, the image-receiving layer also functions as a masking layer. The ratio of the binder resin relative to the masking agent (weight ratio) is about 99/1 to 30/70, preferably about 90/10 to 40/60, and more preferably about 80/20 to 50/50 (in particular, about 70/30 to 50/50).

The image-receiving layer may comprise the above-mentioned additive(s). The thickness of the image-receiving layer is not more than 5 μm (e.g., about 5 to 50 μm), preferably about 10 to 40 μm, and more preferably about 15 to 30 μm.

Moreover, if necessary, a porous layer, an antiblocking layer, a lubricating layer, an antistatic layer and others may be formed on the transfer layer.

[Production Process]

The transfer sheet of the present invention can be produced by forming the transfer layer on at least one side of the support. The transfer layer can be formed by coating on a release surface of the support with a coating agent comprising the above-mentioned component(s) in accordance with a layer structure of the transfer sheet. The binder resin component can be usually used in the form of an aqueous solution or an emulsion. Therefore, the coating agent for a transfer layer can be prepared by mixing an aqueous solution or emulsion containing a binder resin component with other components. A solvent for an aqueous solution or an aqueous emulsion may be water only, or may optionally contain a hydrophilic organic solvent such as an alcohol.

The coating agent can be applied on at least one side of the support by a conventional method such as roller coating, air knife coating, blade coating, rod coating, bar coating, comma coating or graver coating. The coating layer can be formed by drying the coating agent at a temperature of about 50 to 150° C. (preferably, about 80 to 120° C.).

[Method for Forming Image]

The transfer layer formed by the above method (process) is suitable for forming an image by an ink jet printing (recording) system which comprises ejecting droplets of ink (in particular, aqueous ink) to record. A record image can be thermal-transferred or thermal-conveyed to an object by applying an appropriate pressure (e.g., about 500 to 50,000 Pa) at an appropriate temperature (e.g., about 140 to 250° C., preferably about 140 to 200° C.) for an appropriate period (e.g., about 5 seconds to 1 minute) with bringing the transfer layer into contact with the object. If necessary, the object having the transfer image may be heated for crosslinking.

Concretely, in case of using the reverse image-mode transfer sheet, a method for forming an image comprises recording a reverse image onto the transfer layer (particularly, the image-receiving layer) of the transfer sheet, then bringing the transfer layer (particularly, the image-receiving layer), as a contact surface, into contact with the object and heating the transfer layer, and peeling the support from the transfer sheet. In this case, an obverse image is formed on the object.

In the case of using the obverse image-mode transfer sheet, a method for forming image comprises recording an obverse image onto the transfer layer (particularly, the image-receiving layer) of the transfer sheet, then peeling the support from the transfer sheet, and then bringing a release surface of the transfer layer (particularly, the adhesive layer) into contact with the object and heating the transfer layer. In this case, an obverse image is transferred on the object without reversing the image.

[Object (Object to be Transferred)]

As the object, there may be mentioned two-dimensional or three-dimensional structures made of various materials such as fibers, papers, woods, plastics, ceramics and metals. Fabrics (e.g., T-shirts), plastic films or sheets, papers, and others may be usually employed as the object. Since the transfer sheet of the present invention is excellent in masking property, a sharp or clear image can be formed regardless of a color of an object. The transfer sheet is preferably used for a deep-colored object among the objects. The deep-colored object may be either an object of which inherent color is deep color, or an object dyed or stained with deep color. The deep color includes black, gray, dark blue (navy blue), blue, and the like (e.g., a color of which a brightness is about 0 to 0.5, and preferably about 0 to 3).

### Industrial Applicability

The transfer sheet of the present invention realizes that a record image is formed clearly or sharply to an object even when the object is colored. Moreover, the transfer sheet realizes that a clear or sharp record image is formed to an object being deep-colored or having low brightness, and that a thermal-transferred record image can be adhered to an object strongly. The object is also excellent in texture even by thermal-transferring a record image. Further, the transfer sheet ensures improvable water resistance and washing resistance, and maintains (or keeps up) a clear or sharp record image thermal-transferred to an object for a long time.

### EXAMPLES

The following examples are intended to describe this invention in further detail and should by no means be interpreted as defining the scope of the invention. Incidentally, unless otherwise indicated, “part(s)” indicates the proportion by weight. Moreover, the species or characteristics of the transfer sheets obtained in Examples and Comparative Examples and methods for evaluating various capabilities or properties of the transfer sheets are shown as follows.

[Image Clearness (Or Sharpness)]

With contacting a transfer layer surface (record image-receiving surface, a surface to be received an image) of a transfer sheet with a mixed cloth comprising a blackened polyethylene terephthalate (PET) and a cotton [the blackened PET/the cotton=50/50 (weight ratio)] or a mixed cloth comprising a whitened PET and a cotton [the whitened PET/the cotton=50/50 (weight ratio)], the transfer layer was transferred to the cloth at a temperature of 180° C. and under a pressure of 10 g/cm² for 4 minutes with the use of an iron. Then, a support sheet (release paper) was separated from the transfer sheet, a Lab value was measured in the parts where the record image was transferred with use of a chroma meter (manufactured by Minolta Co., Ltd., CR 2000), and a ΔLab value (a difference between a Lab value in case of having a cloth and a Lab value in case of having no cloth) was calculated. The ΔLab value of the mixed cloth comprising the blackened PET and the cotton (black cloth) was compared to that of the mixed cloth comprising the whitened PET and the cotton (white cloth), and image clearness (or sharpness) (masking property) was evaluated on the basis of the following criteria. Incidentally, concerning each of transfer sheets of Examples 22 to 69, a release paper was peeled from the transfer sheet in advance before heating and pressurizing with use of an iron, and thermal-transferring was carried out.

A: a difference between the ΔLab value of the black cloth and that of the white cloth is below 2

B: a difference between the ΔLab value of the black cloth and that of the white cloth is not less than 2 and below 5

C: a difference between the ΔLab value of the black cloth and that of the white cloth is not less than 5

[Washing Resistance]

With the use of an ink jet printer (manufactured by Epson, Co. Ltd., PM-900C), a predetermined image was printed on the transfer sheet with cyane (C), magenta (M), yellow (Y) and black (K) inks to form a record image as a reverse image. A surface of a record image of the transfer sheet was contacted with the white cloth, and the record image was transferred to the cloth at a temperature of 180° C. and under a pressure of 10 g/cm² for 4 minutes with use of an iron. After washing the cloth under the following washing condition, the transferred part was observed visually and washing resistance was evaluated on the basis of the following criteria. Incidentally, concerning each of transfer sheets of Examples 22 to 69, a record image was printed as an obverse image, a release paper was peeled from the transfer sheet in advance before heating and pressurizing with use of an iron, and thermal-transferring was carried out.

(Washing Condition)

With use of a household washing machine (manufactured by Sanyo Electric Co., Ltd.), the washing operation was carried out by adding 1 g/L of a commercially available detergent to a warmed water at 40° C., washing for 15 minutes, rinsing for 20 minutes and drying for 5 minutes. This cycle was repeated 5 times.

(Evaluation Criteria)

A: no crack (chap or craze) or peeling (separation) in the transferred parts

B: a small amount of cracks (chaps or crazes) or peeling (separation) is present in the transferred parts

C: a large amount of cracks (chaps or crazes) or peeling (separation) is present in the transferred parts

[Discoloring With Wash]

With the use of the above-mentioned ink jet printer, on the transfer sheet was solid-printed each color of cyane (C), magenta (M), yellow (Y), black (K), red (R), green (G) and blue (B) inks. A surface of a record image of the transfer sheet was contacted with the above-mentioned white cloth, and the record image was thermal-transferred to the cloth in the same manner as mentioned above with the use of an iron. A release paper was peeled from the transfer sheet, and a color density in the colored parts of each color was measured by a reflection-mode (reflection-type) Macbeth densitomater (manufactured by Sakata Inx Corp., RD-1200). Furthermore, after washing the cloth under the above washing conditions, the color density in the colored parts of each color was measured again. A retention ratio of a color density was calculated by the following formula, and the degree of discoloring with wash was evaluated on the basis of the following criteria. Incidentally, the release paper was peeled from the transfer sheet in the same manner as in the test of image clearness.
Retention ratio of a color density=(a color density after washing/a color density before washing)×100 (%)
(Evaluation Criteria)

A: retention ratio of a color density is not less than 90%

B: retention ratio of a color density is not less than 80% and below 90%

C: retention ratio of a color density is below 80%

[Texture]

Concerning a cloth in which the transfer sheet was thermal-transferred to the white cloth with use of an iron in the same manner mentioned above, texture was evaluated on the basis of the following criteria. Incidentally, the release paper was peeled from the transfer sheet in the same manner as in the test of image clearness.

A: the cloth is soft and the transfer layer is not recognized

B: the cloth is roughish

C: the cloth is stiff and the transfer layer is recognized

### Examples 1 to 7 and Comparative Example 1

A sheet having a protecting layer was obtained by coating a cationic urethane-series resin emulsion containing a quaternary ammonium salt (manufactured by Daiichi Kogyo Seiyaku, Co. Ltd., F-8559D) on a cray-coated and silicon-coated paper (90 μm thick). Further, an aqueous coating solution (or coating agent) was prepared by mixing a nylon powder (manufactured by Daicel Huels, Co. Ltd., Vestamelt 430P06), a dye fixing agent (manufactured by Senka, Co. Ltd., PAPIOGEN P109, a quaternary ammonium salt-containing composition), a binder (manufactured by Sanyo Kasei Kogyo, Co. Ltd., PEG4000S, a polyethylene glycol) and a titanium oxide in the proportion shown in Table 1 (on solid basis), and the aqueous coating agent was coated on the protecting layer of the sheet and dried to give a transfer sheet, which comprises a protecting layer and an image-receiving layer having thickness shown in Table 1, respectively. The evaluation results of thus obtained transfer sheet are shown in Table 1.

TABLE 1

| | | Com. | | | | | | | |
|---|---|---|---|---|---|---|---|---|---|
| | | Ex. | Examples | | | | | | |
| | | 1 | 1 | 2 | 3 | 4 | 5 | 6 | 7 |
| Image- | Nylon fine | 85 | 76 | 72 | 76 | 75 | 75 | 75 | 75 |
| receiving | particle | | | | | | | | |
| layer | Dye fixing agent | 11 | 10 | 9 | 10 | 11 | 11 | 11 | 11 |
| (parts by | PEG | 4 | 4 | 4 | 4 | 4 | 4 | 4 | 4 |
| weight) | Titanium oxide | — | 10 | 15 | 10 | 10 | 10 | 10 | 10 |
| Thickness of image-receiving | | 40 | 40 | 40 | 50 | 60 | 70 | 80 | 80 |
| layer (μm) | | | | | | | | | |
| Thickness of protecting layer | | 10 | 10 | 10 | 10 | 10 | 10 | 10 | 5 |
| (μm) | | | | | | | | | |
| Performance | Image clearness | C | B | A | B | A | A | A | A |
| | Washing | A | A | B | A | A | A | A | A |
| | resistance | | | | | | | | |
| | Discoloring with | A | B | A | B | A | A | A | B |
| | wash | | | | | | | | |
| | Texture | A | A | B | A | A | A | A | B |

As apparent from the results in Table 1, since the transfer sheet of Comparative Example 1 comprises no titanium oxide, masking property is not enough and image clearness is low in the Comparative Example. The transfer sheets of Examples 1 to 7 are excellent in balance of each performance.

### Examples 8 to 14

A transfer sheet, which comprises a protecting layer and an image-receiving layer having thickness shown in Table 2, was obtained in the similar manner as in Examples 1 to 7 except that the image-receiving layer was prepared in the proportion shown in Table 2 by using a microcapsule (manufactured by Matsumoto Yushi-Seiyaku Co., Ltd., MATSUMOTO MICROSPHERE F-50) instead of the titanium oxide. The evaluation results of thus obtained transfer sheet are shown in Table 2.

TABLE 2

| | | Examples | | | | | | |
|---|---|---|---|---|---|---|---|---|
| | | 8 | 9 | 10 | 11 | 12 | 13 | 14 |
| Image-receiving | Nylon fine particle | 71 | 68 | 71 | 71 | 71 | 71 | 71 |
| layer | Dye fixing agent | 9 | 8 | 9 | 9 | 9 | 9 | 9 |
| (parts by weight) | PEG | 4 | 4 | 4 | 4 | 4 | 4 | 4 |
| | Microcapsule | 16 | 20 | 16 | 16 | 16 | 16 | 16 |
| Thickness of image-receiving layer | | 40 | 40 | 50 | 60 | 70 | 80 | 80 |
| (μm) | | | | | | | | |
| Thickness of protecting layer (μm) | | 10 | 10 | 10 | 10 | 10 | 10 | 5 |
| Performance | Image clearness | B | A | B | A | A | A | A |
| | Washing resistance | A | B | A | A | A | A | A |
| | Discoloring with | B | A | B | A | A | A | B |
| | wash | | | | | | | |
| | Texture | A | B | A | A | A | A | B |

As apparent from the results in Table 2, the transfer sheets of Examples 8 to 14 are excellent in balance of each performance.

### Examples 15 to 21

A transfer sheet, which comprises a protecting layer and an image-receiving layer having thickness shown in Table 3, was obtained in the similar manner as in Examples 1 to 7, except that the image-receiving layer was prepared in the proportion shown in Table 3, by using a white pigment-containing polyurethane resin fine particle (manufactured by Dainippon Ink and Chemicals, Inc., NORBACK CFB-100) instead of the titanium oxide. The evaluation results of thus obtained transfer sheet are shown in Table 3.

TABLE 3

| | | Examples | | | | | | |
|---|---|---|---|---|---|---|---|---|
| | | 15 | 16 | 17 | 18 | 19 | 20 | 21 |
| Image-receiving | Nylon fine particle | 75 | 71 | 75 | 74 | 74 | 74 | 74 |
| layer | Dye fixing agent | 9 | 8 | 9 | 10 | 10 | 10 | 10 |
| (parts by weight) | PEG | 3 | 3 | 3 | 3 | 3 | 3 | 3 |
| | Urethane fine | 13 | 18 | 13 | 13 | 13 | 13 | 13 |
| | particle | | | | | | | |
| Thickness of image-receiving layer | | 40 | 40 | 50 | 60 | 70 | 80 | 80 |
| (μm) | | | | | | | | |
| Thickness of protecting layer (μm) | | 10 | 10 | 10 | 10 | 10 | 10 | 5 |
| Performance | Image clearness | B | A | B | A | A | A | A |
| | Washing resistance | A | B | A | A | A | A | A |
| | Discoloring with | B | A | B | A | A | A | B |
| | wash | | | | | | | |
| | Texture | A | B | A | A | A | A | B |

As apparent from the results in Table 3, the transfer sheets of Examples 15 to 21 are excellent in balance of each performance.

### Examples 22 to 29

An aqueous coating solution (or coating agent) was prepared by mixing a cationic urethane-series resin emulsion containing a quaternary ammonium salt (manufactured by Daiichi Kogyo Seiyaku, Co. Ltd., F-8559D) and a titanium oxide in the proportion shown in Table 4 (on solid basis), and thus obtained aqueous coating agent was coated on a cray-coated and silicon-coated paper (90 μm thick) to give a sheet having an adhesive layer (masking layer). Further, an aqueous coating solution (or coating agent) was prepared by mixing a binder [manufactured by Takamatsu Oil & Fat Co., Ltd., NS-120X, an aqueous acrylic resin water solution (a composite polymer of an acrylic resin, a polyvinyl alcohol and a polyurethane resin)] and a dye fixing agent (manufactured by Senka, Co. Ltd., PAPIOGEN P109, a quaternary ammonium salt-containing composition) in the proportion shown in Table 4 (on solid basis), and thus obtained aqueous coating agent was coated on the adhesive layer of the sheet and dried to give a transfer sheet, which comprises an adhesive layer and an image-receiving layer having thickness shown in Table 4, respectively. The evaluation results of thus obtained transfer sheet are shown in Table 4.

TABLE 4

| | | Examples | | | | | | | |
|---|---|---|---|---|---|---|---|---|---|
| | | 22 | 23 | 24 | 25 | 26 | 27 | 28 | 29 |
| Image- | Aqueous acrylic | 90 | 90 | 90 | 90 | 90 | 90 | 90 | 90 |
| receiving layer | resin | | | | | | | | |
| (parts by | Dye fixing agent | 10 | 10 | 10 | 10 | 10 | 10 | 10 | 10 |
| weight) | | | | | | | | | |
| Thickness of image-receiving | | 20 | 20 | 20 | 20 | 10 | 10 | 10 | 5 |
| layer (μm) | | | | | | | | | |
| Masking layer | Urethane-series | 90 | 80 | 80 | 80 | 80 | 80 | 80 | 80 |
| (parts by | resin | | | | | | | | |
| weight) | Titanium oxide | 10 | 20 | 20 | 20 | 20 | 20 | 20 | 20 |
| Thickness of masking layer (μm) | | 40 | 40 | 50 | 60 | 70 | 80 | 50 | 50 |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 4, the transfer sheets of Examples 22 to 29 are excellent in balance of each performance.

### Examples 30 to 37

A transfer sheet, which comprises an adhesive layer and an image-receiving layer having thickness shown in Table 5, respectively, was obtained in the similar manner as in Examples 22 to 29 except that an adhesive layer was prepared in the proportion shown in Table 5 by using a microcapsule (manufactured by Matsumoto Yushi-Seiyaku Co., Ltd., MATSUMOTO MICROSPHERE F-50) instead of the titanium oxide. The evaluation results of thus obtained transfer sheet are shown in Table 5.

TABLE 5

| | | Examples | | | | | | | |
|---|---|---|---|---|---|---|---|---|---|
| | | 30 | 31 | 32 | 33 | 34 | 35 | 36 | 37 |
| Image- | Aqueous acrylic | 90 | 90 | 90 | 90 | 90 | 90 | 90 | 90 |
| receiving layer | resin | | | | | | | | |
| (parts by | Dye fixing agent | 10 | 10 | 10 | 10 | 10 | 10 | 10 | 10 |
| weight) | | | | | | | | | |
| Thickness of image-receiving | | 20 | 20 | 20 | 20 | 10 | 10 | 10 | 5 |
| layer (μm) | | | | | | | | | |
| Masking layer | Urethane-series | 84 | 68 | 68 | 68 | 68 | 68 | 68 | 68 |
| (parts by | resin | | | | | | | | |
| weight) | Microcapsule | 16 | 32 | 32 | 32 | 32 | 32 | 32 | 32 |
| Thickness of masking layer (μm) | | 40 | 40 | 50 | 60 | 70 | 80 | 50 | 50 |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 5, the transfer sheets of Examples 30 to 37 are excellent in balance of each performance.

### Examples 38 to 45

A transfer sheet, which comprises an adhesive layer and an image-receiving layer having thickness shown in Table 6, respectively, was obtained in the similar manner as in Examples 22 to 29 except that an adhesive layer was prepared in the proportion shown in Table 6 by using a white pigment-containing polyurethane resin fine particle (manufactured by Dainippon Ink and Chemicals, Inc., NORBACK CFB-100) instead of the titanium oxide. The evaluation results of thus obtained transfer sheet are shown in Table 6.

TABLE 6

| | | Examples | | | | | | | |
|---|---|---|---|---|---|---|---|---|---|
| | | 38 | 39 | 40 | 41 | 42 | 43 | 44 | 45 |
| Image- | Aqueous acrylic | 90 | 90 | 90 | 90 | 90 | 90 | 90 | 90 |
| receiving layer | resin | | | | | | | | |
| (parts by | Dye fixing agent | 10 | 10 | 10 | 10 | 10 | 10 | 10 | 10 |
| weight) | | | | | | | | | |
| Thickness of image-receiving | | 20 | 20 | 20 | 20 | 10 | 10 | 10 | 5 |
| layer (μm) | | | | | | | | | |
| Masking layer | Urethane-series | 88 | 76 | 76 | 76 | 76 | 76 | 76 | 76 |
| (parts by | resin | | | | | | | | |
| weight) | Microcapsule | 12 | 24 | 24 | 24 | 24 | 24 | 24 | 24 |
| Thickness of masking layer (μm) | | 40 | 40 | 50 | 60 | 70 | 80 | 50 | 50 |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 6, the transfer sheets of Examples 38 to 45 are excellent in balance of each performance.

### Examples 46 to 53

A sheet having an adhesive layer was obtained by coating a cationic urethane-series resin emulsion containing a quaternary ammonium salt (manufactured by Daiichi Kogyo Seiyaku, Co. Ltd., F-8559D) on a cray-coated and silicon-coated paper (90 Mm thick). Further, an aqueous coating solution (or coating agent) was prepared by mixing a binder [manufactured by Takamatsu Oil & Fat Co., Ltd., NS-120X, an aqueous acrylic resin water solution (a composite polymer of an acrylic resin, a polyvinyl alcohol and a polyurethane resin)] and a dye fixing agent (manufactured by Senka, Co. Ltd., PAPIOGEN P109, a quaternary ammonium salt-containing composition) and a titanium oxide in the proportion shown in Table 7 (on solid basis), and thus obtained aqueous coating agent was coated on the adhesive layer of the sheet and dried to give a transfer sheet, which comprises an adhesive layer and an image-receiving layer (masking layer) having thickness shown in Table 7. The evaluation results of thus obtained transfer sheet are shown in Table 7.

TABLE 7

| | | Examples | | | | | | | |
|---|---|---|---|---|---|---|---|---|---|
| | | 46 | 47 | 48 | 49 | 50 | 51 | 52 | 53 |
| Thickness of thermal-adhesive | | 20 | 20 | 20 | 20 | 20 | 20 | 20 | 20 |
| layer (μm) | | | | | | | | | |
| Image- | Aqueous acrylic | 87 | 79 | 87 | 87 | 87 | 87 | 87 | 87 |
| receiving layer | resin | | | | | | | | |
| (parts by | Dye fixing agent | 5 | 5 | 5 | 5 | 5 | 5 | 5 | 5 |
| weight) | Titanium oxide | 8 | 16 | 8 | 8 | 8 | 8 | 8 | 8 |
| Thickness of image-receiving | | 40 | 40 | 50 | 60 | 70 | 80 | 50 | 50 |
| layer (μm) | | | | | | | | | |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 7, the transfer sheets of Examples 46 to 53 are excellent in balance of each performance.

### Examples 54 to 61

A transfer sheet, which comprises an adhesive layer and an image-receiving layer having thickness shown-in Table 8, was obtained in the similar manner as in Examples 46 to 53 except that an image-receiving layer was prepared in the proportion shown in Table 8 by using a microcapsule (manufactured by Matsumoto Yushi-Seiyaku Co., Ltd., MATSUMOTO MICROSPHERE F-50) instead of the titanium oxide. The evaluation results of thus obtained transfer sheet are shown in Table 8.

TABLE 8

| | | Examples | | | | | | | |
|---|---|---|---|---|---|---|---|---|---|
| | | 54 | 55 | 56 | 57 | 58 | 59 | 60 | 61 |
| Thickness of thermal-adhesive | | 20 | 20 | 20 | 20 | 20 | 20 | 20 | 20 |
| layer (μm) | | | | | | | | | |
| Image- | Aqueous acrylic | 82 | 69 | 82 | 82 | 82 | 82 | 82 | 82 |
| receiving layer | resin | | | | | | | | |
| (parts by | Dye fixing agent | 5 | 5 | 5 | 5 | 5 | 5 | 5 | 5 |
| weight) | Microcapsule | 13 | 26 | 13 | 13 | 13 | 13 | 13 | 13 |
| Thickness of image-receiving | | 40 | 40 | 50 | 60 | 70 | 80 | 50 | 50 |
| layer (μm) | | | | | | | | | |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 8, the transfer sheets of Examples 54 to 61 are excellent in balance of each performance.

### Examples 62 to 69

A transfer sheet, which comprises an adhesive layer and an image-receiving layer having thickness shown in Table 9, was obtained in the similar manner as in Examples 46 to 53 except that an image-receiving layer was prepared in the proportion shown in Table 9 by using a white pigment-containing polyurethane resin fine particle (manufactured by Dainippon Ink and Chemicals, Inc., NORBACK CFB-100) instead of the titanium oxide. The evaluation results of thus obtained transfer sheet are shown in Table 9.

TABLE 9

| | | Examples | | | | | | | |
|---|---|---|---|---|---|---|---|---|---|
| | | 62 | 63 | 64 | 65 | 66 | 67 | 68 | 69 |
| Thickness of thermal-adhesive | | 20 | 20 | 20 | 20 | 20 | 20 | 20 | 20 |
| layer (μm) | | | | | | | | | |
| Image- | Aqueous acrylic | 85 | 75 | 85 | 85 | 85 | 85 | 85 | 85 |
| receiving layer | resin | | | | | | | | |
| (parts by | Dye fixing agent | 5 | 5 | 5 | 5 | 5 | 5 | 5 | 5 |
| weight) | Urethane fine | 10 | 20 | 10 | 10 | 10 | 10 | 10 | 10 |
| | particle | | | | | | | | |
| Thickness of image-receiving | | 40 | 40 | 50 | 60 | 70 | 80 | 50 | 50 |
| layer (μm) | | | | | | | | | |
| Performance | Image clearness | B | A | B | A | A | A | A | A |
| | Washing | A | B | A | A | A | A | A | A |
| | resistance | | | | | | | | |
| | Discoloring with | B | A | B | A | A | A | A | B |
| | wash | | | | | | | | |
| | Texture | A | B | A | A | A | B | A | A |

As apparent from the results in Table 9, the transfer sheets of Examples 62 to 69 are excellent in balance of each performance.

1. A transfer sheet comprising a support and a transfer layer separable from the support, wherein the transfer layer comprises at least a hot-melt adhesive resin and a masking agent,
wherein the masking agent comprises at least one member selected from the group consisting of a resin fine particle and a microcapsule,
wherein the resin fine particle comprises at least a resin and a white pigment.

2. A transfer sheet according to claim 1, wherein microcapsule is capable of whitening.

3. A transfer sheet according to claim 1 A, wherein the average particle size of the white pigment is not larger than 3 μm.

4. A transfer sheet according to claim 1 A, wherein the white pigment comprises a titanium oxide.

5. A transfer sheet according to claim 1 wherein the resin constituting the resin fine particle comprises at least a hot-melt adhesive resin.

6. A transfer sheet according to claim 1 A, wherein the average particle size of the microcapsule is not larger than 50 μm, and the microcapsule expands not less than three times by volume by heating at 150° C. for one minute.

7. A transfer sheet according to claim 1, wherein the transfer layer is formed as an image-receiving layer containing a hot-melt adhesive resin fine particle, a binder resin and a masking agent.

8. A transfer sheet according to claim 7, wherein the image-receiving layer further comprises a dye fixing agent.

9. A transfer sheet according to claim 7, wherein the image-receiving layer comprises 0.1 to 20 parts by weight of the binder resin and 1 to 30 parts by weight of the masking agent relative to 100 parts by weight of the hot-melt adhesive resin.

10. A transfer sheet according to claim 8, wherein the image-receiving layer comprises 0.5 to 30 parts by weight of the dye fixing agent relative to 100 parts by weight of the hot-melt adhesive resin.

11. A transfer sheet according to claim 7, wherein the transfer layer comprises a protecting layer separable from a support, and an image-receiving layer formed on the protecting layer.

12. A transfer sheet according to claim 11, wherein the protecting layer comprises a cationic resin or a urethane-series resin.

13. A transfer sheet comprising a support, a protecting layer separable from the support, and an image-receiving layer formed on the protecting layer, wherein the protecting layer comprises a cationic thermoplastic urethane-series resin, the image-receiving layer comprises a polyamide-series resin fine particle, a polyoxyalkylene glycol, a cationic compound and a masking agent, and
the image-receiving layer comprises 0.5 to 15 parts by weight of the polyoxyalkylene glycol, 1 to 25 parts by weight of the cationic compound and 5 to 20 parts by weight of the masking agent relative to 100 parts by weight of the polyamide-series resin fine particle.

14. A transfer sheet according to claim 1, wherein the transfer layer comprises
an adhesive layer separable from the support and comprising at least a hot-melt adhesive resin, and
an image-receiving layer formed on the adhesive layer and comprising a binder resin and a dye fixing agent, and
wherein at least one layer among the adhesive layer and image-receiving layer comprises a masking agent.

15. A transfer sheet according to claim 14, wherein the adhesive layer comprises the hot-melt adhesive resin and the masking agent, and the ratio of the hot-melt adhesive resin relative to the masking agent (weight ratio) is 99/1 to 30/70.

16. A transfer sheet according to claim 14, wherein the image-receiving layer comprises the masking agent, and the ratio of the binder resin relative to the masking agent (weight ratio) is 99/1 to 30/70.

17. A transfer sheet according to claim 14, wherein the ratio of the binder resin relative to the dye fixing agent in the image-receiving agent (weight ratio) is 99/1 to 60/40.

18. A transfer sheet according to claim 15, wherein the image-receiving layer comprises
a composite polymer composed of a hydrophilic polymer and a crosslinking group-containing polymer, and
a cationic compound, and
wherein the ratio of the hot-melt adhesive resin relative to the masking agent in the adhesive layer (weight ratio) is 90/10 to 40/60, and the ratio of the composite polymer relative to the cationic compound in the image-receiving layer (weight ratio) is 97/3 to 70/30.

19. A transfer sheet according to claim 16, wherein the image-receiving layer comprises a composite polymer composed of a hydrophilic polymer and a crosslinking group-containing polymer, a cationic compound and the masking agent, and the ratio of the composite polymer relative to the masking agent in the image-receiving layer (weight ratio) is 90/10 to 40/60, and the ratio of the composite polymer relative to the cationic compound (weight ratio) is 97/3 to 70/30.

20. A transfer sheet according to claim 1, which is used for forming an image by transferring the transfer layer to a colored object.

21. A method for forming a record image, which comprises recording an image onto a transfer layer of a transfer sheet recited in claim 1 by means of an ink jet recording system, and separating the imaged transfer layer from a support to transfer the imaged transfer layer to a colored object.

22. A method for forming a record image, which comprises recording an image onto an image-receiving layer of a transfer sheet recited in claim 7 by means of an ink jet recording system, heating the image-receiving layer with the layer contacted with a colored object, and then separating the image-receiving layer from a support to transfer the imaged layer to the object.

23. A method for forming a record image, which comprises recording an image onto an image-receiving layer of a transfer sheet recited in claim 14 by means of an ink jet recording system, separating a support from an adhesive layer, heating the adhesive layer with the layer contacted with a colored object, and transferring the adhesive layer and the imaged layer to the object.
